(19) United States
(12) Patent Application Publication
(10) Pub. No.: US 2022/0344674 A1
(43) Pub. Date: Oct. 27, 2022

(54) AEROGEL-BASED OXYGEN-REDUCTION CATALYSTS AND PROCESSES FOR PRODUCING SAME

(71) Applicant: BAR-ILAN UNIVERSITY, Ramat Gan (IL)

(72) Inventors: Lior ELBAZ, Beer-Sheva (IL); Noam ZION, Kfar Saba (IL)

(21) Appl. No.: 17/640,110

(22) PCT Filed: Sep. 10, 2020
(86) PCT No.: PCT/IL2020/050989

§ 371 Date: Mar. 3, 2022

Related U.S. Application Data
(60) Provisional application No. 62/899,168, filed on Sep. 12, 2019.

(51) Int. Cl. H01M 4/90

(52) U.S. Cl. CPC H01M 4/9008

(57) ABSTRACT

The present disclosure relates to aerogels based on transition metal complexes, preparation thereof and there use as highly active atomically dispersed oxygen-reduction catalyst with ultra-high catalytic site density and metal content.

### FIELD OF THE INVENTION

The present disclosure encompasses aerogels based on transition metal complexes, process for preparation thereof and their use as catalysts for oxygen-reduction reactions.

### BACKGROUND OF THE INVENTION

The oxygen-reduction reaction (ORR) is one of the most important reactions in nature. Its relative slow kinetics is catalyzed by various enzymes to facilitate a wide range of processes in biological systems, from metabolism to respiration. In nature, transition metal complexes, mainly metallo-porphyrins, are the catalytic centers in enzymes such as cytochrome C oxidase. The interest in the catalysis of this reaction further increased in the recent years due to its critical role in some alternative energy technologies, which require high reaction rates and high thermodynamic efficiency. Although platinum-group metals (PGM) can catalyze the ORR quite effectively, their major drawbacks are limited availability and high cost.

Other issues in the field of catalysts, which may be even more important than high reaction rates and high thermodynamic efficiency, are the durability and the chemical stability of catalyst supports, in particular, carbon-based catalysts.

In the past couple of decades, great advancements have been achieved in the development of PGM-free catalysts based on earth-abundant elements, nitrogen, carbon and transition metals (usually Fe or Co), inspired by biological systems such as porphyrins and phthalocyanines. In order to overcome the poor stability and low catalytic activity of transition-metal complexes, a new class of high temperature-treated (HT-treated) catalysts, composed of the same elements, i.e., a transition metal, carbon and nitrogen, was developed. Although HT-treated PGM-free catalysts exhibit improved activity and stability, their performance remains inferior to PGM catalysts, calling for further improvements to make them a viable alternative to the state-of-the-art materials. This is mainly due to their intrinsically low turnover frequency, which can only be compensated by forming some highly dense catalytic frameworks.

Aerogels are ultralight, porous materials, with ultra-low density and high void volume (>97%), also known for their unique physicochemical properties such as high porosity, controllable pore size and surface area, as well as low thermal conductivity

It is therefore an object of the present invention to provide new ORR catalysts, such as aerogel-based catalysts, having high site density and large surface area.

It is also an object of the present invention to provide a process for the preparation of said aerogel-based ORR catalysts.

Other objects and advantages of the invention will become apparent as the description proceeds.

### SUMMARY OF THE INVENTION

In one aspect of the invention, there is provided an aerogel catalyst comprising a central transition metal complex comprising macrocyclic compounds as ligands and cross-linkers for use in oxygen-reduction reactions.

According to one embodiment of the invention, the aerogel catalyst has a catalytic site density of 1×10¹⁹ to 1×10²° sites cm⁻³. In a specific embodiment, the catalytic site density in the aerogel catalyst is 4×10¹⁹ sites cm⁻³.

According to another embodiment of the invention, the transition metal is selected from the group consisting of iron, cobalt, copper, nickel, vanadium, manganese, chromium, ruthenium, rhodium, iridium, osmium, rhenium, molybdenum, tungsten and any combination thereof.

According to yet another embodiment, the macrocyclic compound is porphyrin, phthalocyanine, phenanthroline, corrole or bipyridine.

According to a further embodiment of the invention, the aerogel catalyst has a metal content of about 2 wt. % to about 9 wt. %. According to a specific embodiment, the metal content is about 6.5 wt. % to about 9.0 wt. %.

According to yet a further embodiment, the aerogel catalyst has a Brunauer-Emmett-Teller (BET) surface area of about 150-700 m²/g.

In another aspect, the present invention provides a process for preparing an aerogel catalyst, the process comprising the steps of:
(a) heating a reaction mixture at about 60-160° C. to obtain a gel, the reaction mixture comprising:
   a solution comprising monomers of a pyrrolic or a pyridinic compound and transition metal ions; wherein the ratio between the metal ions and the monomer in the reaction mixture is from 7:1 to 10:1; and
   a solution comprising a cross-linker, such that the molar ratio between the —NH₂ of the monomer to the —CHO of the cross-linker is from 1:1 to 1:4;
(b) washing the gel; and
(c) supercritically drying the gel using high pressure drying liquid to obtain an aerogel; and
(d) subjecting the aerogel to heat treatment of at least 500° C. for at least 1 hour.

The present invention also provides a process for preparing an aerogel catalyst, wherein steps (a) comprises the steps of:
(i) heating a reaction mixture comprising a solvent, monomers of a pyrrolic or a pyridinic compound and transition metal ions at about 60-160° C. for 20 to 60 minutes; wherein the ratio between the metal ions and the monomer in the reaction mixture is from 7:1 to 10:1;
(ii) adding a solution of a cross-linker to the reaction mixture, such that the molar ratio between the —NH₂ of the monomer to the —CHO of the cross-linker is from 1:1 to 1:4; and
(iii) heating the reaction mixture containing the cross-linker about 60-160° C. to obtain a gel.

According to one embodiment of the invention, the final concentration of the metal ions in the reaction mixture is from 0.25 M to 0.3 M.

According to another embodiment of the invention, the final concentration of the monomer in the reaction mixture is from 10 mg/mL to 200 mg/mL.

The pyrrolic or the pyridinic compound may be in the form of a free base or a hydroxyl analogue thereof.

In a specific embodiment of the invention, the solvent is dimethyl sulfoxide (DMSO).

In another specific embodiment, the cross-linker is terephthalaldehyde (TPA) and is dissolved in DMSO.

In some embodiments, the step of washing the gel comprises exchanging the solvent of the gel to a washing liquid. Optionally, prior to exchanging the solvent of the gel to a washing liquid, the gel is immersed in a fresh solvent of the same type as the solvent used to dissolve the metal ions, monomers and cross-linker, once daily for four days or until no residues of unreacted molecules can be detected in the solvent.

In one embodiment of the invention, the washing liquid is selected from acetone, methanol, ethanol or isopropanol.

According to another embodiment of the invention, the drying liquid is liquid CO₂.

According to a further embodiment, the heat treatment is low temperature heat treatment (LTHT) at a temperature of about 500° C. to about 1000° C.

In a specific embodiment, the LTHT is carried at a temperature of from 800° C.

In a further aspect, the invention provides an aerogel catalyst produced according to the process as described above.

In one embodiment, the aerogel catalyst of the invention can be used as an oxygen-reduction reaction (ORR) catalyst.

In another embodiment, the aerogel catalyst of the invention can be used in fuel cells, Li-air batteries, CO₂ reduction reaction, electrolyzers and sensors.

### BRIEF DESCRIPTION OF THE DRAWINGS

FIG. 1A schematically illustrates the process for the preparation of metallo-porphyrin aerogel according to one embodiment of the invention. Abbreviations: M (transitional metal); cat. (catalyst).

FIG. 1B shows 30 mg of porphyrin powder (left) and the porphyrin aerogel synthesized from the same amount of porphyrin (right).

FIG. 1C shows an Fe-porphyrin aerogel before (right) and after (left) low temperature heat treatment (LTHT).

FIG. 2 shows FTIR-ATR comparison of 5,10,15,20-(tetra-4-aminophenyl)porphyrin (TAPP) monomer powder (a), TAPP aerogel (b), and Fe-TAPP aerogel (c). The arrows mark the peak at 1621 cm⁻¹.

FIG. 3A shows the N 1s XPS spectrum of the Fe-TAPP aerogel.

FIG. 3B shows the Fe 2p XPS spectrum of the Fe-TAPP aerogel.

FIG. 4A shows the N 1s XPS spectrum of the Fe-TAPP aerogel after LTHT at 600° C.

FIG. 4B shows the Fe 2p XPS spectrum of the Fe-TAPP aerogel after LTHT at ° C.

FIG. 5 shows HR-SEM image of LTHT (600° C.)-Fe-TAPP aerogel.

FIG. 6A shows the ADF-STEM images of an LTHT (600° C.)-Fe-TAPP aerogel; (a) and (b) represent the points at which EELS spectra were recorded.

FIG. 6B shows the EELS point spectrum recorded at the point (a) as shown in FIG. 6A.

FIG. 6C shows the EELS point spectrum recorded at the point (b) as shown in FIG. 6A.

FIG. 7 shows the RRDE analysis of the LTHT (600° C.)-Fe-TAPP aerogel (a), Fe-TAPP aerogel (b), and LTHT (600° C.)-TAPP aerogel (c) in O₂-saturated 0.1 M KOH at 900 rpm. Abbreviations: D (disk), R (ring), RHE (reversible hydrogen electrode).

FIG. 8 shows the calculated turnover frequencies (TOF) of LTHT (600° C.)-Fe-TAPP aerogel (a) and non-LTHT treated Fe-TAPP aerogel (b). Abbreviations: RHE (reversible hydrogen electrode).

FIG. 9 shows TGA-MS analysis of an Fe-TAPP aerogel undergoing LTHT up to 1000° C., indicating the molecules released in each mass drop are marked by an arrow.

FIG. 10A shows the Fe 2p XPS spectrum of an Fe-TAPP aerogel after LTHT at 800° C.

FIG. 10B shows the N 1s XPS spectrum of an Fe-TAPP aerogel after LTHT at 800° C.

FIG. 11 shows the iron content in atomic % in Fe-TAPP aerogels that were subjected to LTHT at the indicated temperature compared to an Fe-TAPP aerogel that did not undergo LTHT (Untreated).

FIGS. 12A-12F show ADF-STEM images of an Fe-TAPP aerogel that did not undergo LTHT (A) and Fe-TAPP aerogels subjected to LTHT at 600° C. (B), 700° C. (C), 800° C. (D), 900° C. (E) and 1000° C. (F); white circles mark examples of iron ions within the Fe-TAPP aerogel.

FIG. 13 shows RRDE analysis of Fe-TAPP aerogels after LTHT at 600° C. (a), 700° C. (b), 800° C. (c), 900° C. (d) or 1000° C. (e) in O₂-saturated 0.1 M KOH at 900 rpm.

FIG. 14 shows the calculated turnover frequencies (TOF) of Fe-TAPP aerogels after LTHT at 600° C. (a), 700° C. (b), 800° C. (c), 900° C. (d) or 1000° C. (e). Abbreviations: RHE (reversible hydrogen electrode).

### DETAILED DESCRIPTION OF THE INVENTION

The present disclosure encompasses aerogel catalysts having high catalytic site density, which are based on transition metals such as iron, cobalt or copper in a well-defined, large surface-area covalent organic framework (COF) of aerogels comprising pyrrolic or pyridinic molecules that are connected to each other via their amine substituent. The catalytic site density of the metal-aerogel catalysts of the present disclosure is one order of magnitude higher than that of the state-of-the-art PGM-free catalysts known today. The aerogel catalysts described herein show high selectivity, high activity and high sensitivity for oxygen and can thus be used as oxygen-reduction reaction (ORR) catalysts in fuel cells, Li-air batteries, CO₂ reduction reaction, electrolyzers and sensors, such as oxygen sensors. The present disclosure also encompasses a process for the preparation of said aerogels. The process described herein enables the synthesis of metal-aerogel complexes having a high catalytic performance, while preventing aggregation of the macrocyclic compounds in the reaction mixture prior to their polymerization.

As used herein, the term “catalytic site” refers to a central metal ion coordinated by its ligand/s. The ligands in the complex are pyrrolic or pyridinic macrocyclic compounds, such as porphyrin or phthalocyanine molecules.

The terms “site density (SD)” and “catalytic site density” as used interchangeably herein refer to the number of catalytic sites per unit volume.

The term “covalent organic framework (COF)” as used herein refers to porous two- or three-dimensional organic solids with extended structures in which building blocks are linked by strong covalent bonds that are made entirely from light elements (such as H, B, C, N, and O).

The term “turnover frequency (TOF)” as used herein refers to the maximum number of chemical conversions of substrate molecules per second that a single catalytic site will execute for a given concentration of active sites per time unit. TOF is calculated according to Equation (1):

$$TOF = \frac{{I}_{k}}{F \cdot {n}_{s i t e s}} ( {e}^{-} {s}^{- 1} {site}^{- 1} ) \qquad Equation ( 1 )$$

wherein:
Iₖ is the kinetic current measured at a specific potential;
F (C/mol) is Faraday constant; and
nₛᵢₜₑₛ is the number of moles of active sites.

In one aspect, the present disclosure encompasses an aerogel catalyst also termed herein “metallo-macrocyclic aerogel” or “transition metal-aerogel complex” comprising a central transition metal complex comprising macrocyclic compounds as ligands and cross-linkers for use in oxygen-reduction reactions.

The transition metal-aerogel complex of the present disclosure is useful as an ORR catalyst and is characterized by the transition metal ions being uniformly distributed in the aerogel matrix.

In one embodiment of the invention, the catalytic site density in the aerogel catalyst described herein is in the range of 1×10¹⁹ to 1×10²° sites/cm³. In a specific embodiment of the invention, the site density in the complex is 4×10¹⁹ sites/cm³.

The transition metal in the catalytic site of the aerogel according to the present invention is selected from the group consisting of iron, cobalt, copper, nickel, vanadium, manganese, chromium, ruthenium, rhodium, iridium, osmium, rhenium, molybdenum, tungsten and any combination thereof.

The macrocyclic compound used as a ligand in the catalytic site is a pyrrolic or a pyridinic compound, such as porphyrin, phthalocyanine, phenanthroline, corrole and bipyridine.

In another embodiment of the invention, the metal content in the metallo-macrocyclic aerogel is about 2 to about 15 wt. %. In yet another embodiment of the invention, the metal content in the metallo-macrocyclic aerogel is about 2 to about 9 wt. %. According to a specific embodiment, the metal content in the aerogel of the present invention is about 6.5 to about 9.0 wt. %.

The above content of the metal is the highest content of atomically dispersed metal ions in a PGM-free ORR catalyst from those known in the art. For example, the benchmark iron content of known PGM-free ORR catalysts is below 2 wt. % of atomically dispersed iron ions. This low Fe content and relatively low oxygen turnover frequency (TOF) require high catalyst loading in the fuel cell cathodes, thereby significantly increasing their thickness. Such electrodes tend to suffer from poor mass transfer of reactants and products to and from catalytic centers. Therefore, aerogel catalysts described herein, characterized by high metal content are advantageous over the known ORR catalysts.

In one embodiment of the invention, the aerogel catalyst is also characterized by Brunauer-Emmett-Teller (BET) surface area of about 150-700 m²/g. In a specific embodiment, the BET surface area of the aerogel is about 190 m²/g.

In another aspect, the present disclosure provides a process for preparing the aerogel catalyst described above, comprising the steps of:
(a) heating a reaction mixture comprising:
   a solution comprising monomers of a pyrrolic or a pyridinic compound and transition metal ions; and
   a solution comprising a cross-linker;
(b) washing the gel; and
(c) drying the gel to obtain an aerogel; and
(d) subjecting the aerogel to heat treatment.

The transition metal ion is provided in the solution in the form of a soluble salt. Non-limiting examples of a metal salt include iron(II) chloride tetrahydrate (FeCl₂.4H₂O), iron(II) acetate Fe(CH₃COO)₂, cobalt(II) chloride tetrahydrate (CoCl₂.4H₂O) and cobalt(II) acetate Co(CH₃COO)₂.

In one embodiment, the concentration of the metal ions in the solution is in the range of from 0.25 M to 0.3 M. In a specific embodiment, the concentration of iron(II) chloride tetrahydrate in the solution is about 60 mg/mL.

The salts of the metal ions described above are dissolved in a solvent for the process described above, wherein the most suitable solvent is dimethyl sulfoxide (DMSO). Another solvent that can be used for this purpose is dimethylformamide.

In some embodiments of the invention, the pyrrolic or pyridinic compound is in the form of a free base. In other embodiments, the pyrrolic or pyridinic compound is in the form of a hydroxyl analogue. In a specific embodiment, the monomer of the pyrrolic or pyridinic compound is 5,10,15,20-(tetra-4-aminophenyl)porphyrin (TAPP).

The monomer is added to the solution of transition metal ions in the amount of between 3 mg and 100 mg. In a specific embodiment, 10 mg of monomer are added to the reaction mixture. In another embodiment, the final concentration of the monomer in the solution is about 12 to 400 mg/mL, for example, 40 mg/mL. The ratio between the metal ions and the monomer should be between 7 to 10 metal ions per one monomer.

The cross-linker can be any compound having di- or multi-functional aldehydes, such as terephthalaldehyde, tetrakis-(4-formylphenyl) methane, 1,3,5-triformylbenzene and 1,4-diformylbenzene. In a specific embodiment, the cross-linker is terephthalaldehyde (TPA) having the following structure:

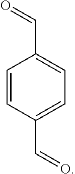

The cross-linker is dissolved in a solvent, such as DMSO. The amount of cross-linker to be added to the reaction mixture is such that there would be a final molar ratio of from 1:1 to 1:4 between the —NH₂ of the macrocyclic compound to the —CHO of the cross-linker. In a specific embodiment, the final molar ration between —NH₂ and —CHO in the reaction mixture is 1:2. The cross-linker solution is preferably added dropwise to the reaction mixture.

In one embodiment of the invention, the solution comprising the cross-linker may also contain other materials that are required for carrying the gelation reaction, such as catalysts and other solvents or reagents. In a specific embodiment, the solution containing the cross-linker also comprises an acid as catalyst, to lower the pH close to 5 and push the reaction from an unstable intermediate bond towards an imine cross-linking bond. In a non-limiting example, the acid catalyst is acetic acid (CH₃COOH).

Typically, the heating is carried out at a temperature of about 60-160° C., depending on the boiling point of the solvent used in the reaction mixture, until a gel is formed, usually overnight. In some embodiments, the reaction mixture is stirred while being heated, until beginning of gelation, such that the stirrer is removed just before gelation takes place. As would be appreciated by a skilled artisan, after its formation, the gel is let to cool to the room temperature.

In some embodiments of the invention, where the complexes of the metal ions and macrocyclic compounds tend to aggregate, such as in the case of Fe-porphyrin complexes, the reaction mixture is first obtained by dissolving transition metal ions (in the form of a salt) and pyrrole- or pyridine-based macrocyclic compounds in a solvent and then the heating is carried out for 20-60 minutes, depending on the incorporating rate of the metal ions to the macrocyclic compound, while stirring. Accordingly, insertion of the metal ions into the macrocyclic compound takes place during the polymerization of the macrocyclic compounds. The solution comprising the cross-linker is added after the metalation of the macrocyclic compound and the heating continues until the gel is formed. It should be noted that adding the metal ions during the polymerization of the macrocyclic molecules has the advantage of preventing aggregation of the macrocyclic compound in the reaction mixture prior to the polymerization reaction due to the coordination of aminophenyl groups in neighboring ligands to the axial positions in the metal center, thus impairing the gelation process.

Accordingly, in one embodiment of the invention, the present disclosure also encompasses a process for preparing the aerogel catalyst described above, wherein step (a) comprises the steps of:
(i) heating a reaction mixture comprising a solution comprising monomers of a pyrrolic or a pyridinic compound and transition metal ions;
(ii) adding a solution comprising a cross-linker to the reaction mixture; and
(iii) heating the reaction mixture containing the cross-linker to obtain a gel.

The washing step includes solvent exchange to a washing liquid by immersing the gel in washing liquid for at least 24 hours. In some embodiments of the invention, prior to the solvent exchange, the gel is immersed in a fresh solvent of the same solvent used to dissolve the materials in the previous steps (metal ions, macrocyclic compounds and cross-linker), usually DMSO, once a day, for four consecutive days, to remove unreacted chemicals until no residues are detected in the solvent above the gel, namely, until the solvent is clear from colored unreacted reagents. In other embodiments, the solvent exchange is carried out 24 hours after the gelation procedure is complete by repeatedly immersing the gel for 24 hours in washing liquid and replacing with fresh washing liquid until the liquid is clear from colored unreacted reagents.

Examples of suitable washing liquids include acetone, methanol, ethanol and isopropanol.

The drying of the gel is typically a supercritical drying. First, the washing liquid is decanted away with high pressure drying liquid, such CO₂. Then, the drying liquid is heated until its temperature reaches the critical point. The gel is held at these conditions for at least 1 hour, after which, the pressure is gradually decreased, allowing the gas to escape and leaving a dried aerogel.

The heat treatment of the aerogel comprises heating the aerogel at a temperature of at least 500° C. for at least one hour. Heating the aerogel is necessary to achieve conductivity of the aerogel catalyst.

In some embodiments of the invention, the heat treatment is a low temperature heat treatment (LTHT).

LTHT optimizes the conductivity of the aerogel catalyst, with minimum effect on the aerogel's macro-structure and transition metal coordination. Following LTHT, the conductivity of the metal-aerogel complexes of the present disclosure increases from completely non-conductive up to about 10 S cm⁻¹. In one embodiment, the conductivity of the ORR catalysts described herein after LTHT is 2.7 S cm⁻¹, a conductivity value that is similar to that of the commercial Vulcan XC72 electrode and about twice that of carbon RF aerogel.

In one embodiment of the invention, LTHT is carried out at a heating rate of between 0.1° C./min and 10° C./min, for example, about 2° C./min starting from room temperature and up to the treating temperature. Then, the aerogel is held at a treating temperature of from about 500° C. to about 1000° C. for between about one hour and four hours. In another embodiment, the temperature of the aerogel is increased from 25° C. to 200° C., and then held at 200° C. for about 2 hours, in order to completely dry the aerogel and prevent formation of oxide layer on its surface. Afterwards, the aerogels is continued to be heated to a treating temperature of from about 500° C. to about 1000° C. at a rate of 2° C./min, and then the aerogel is held for another two hours at the treating temperature.

In a specific embodiment, the aerogel is held at a treating temperature of about 600° C. to 1000° C. for 2 hours. In another specific embodiment, the aerogel is held at a temperature of about 800° C. for 2 hours.

It should be noted that holding the aerogel at a specific treating temperature range during LTHT is critical for producing an aerogel catalyst having high catalytic performances and durability, since at lower temperatures the catalyst may not be graphitic enough, and therefore, less conductive, and at higher temperatures, the catalyst may have less catalytic sites.

The heat treatment is carried out under inert atmosphere, such as Argon, in order to prevent reaction of the aerogel with oxygen.

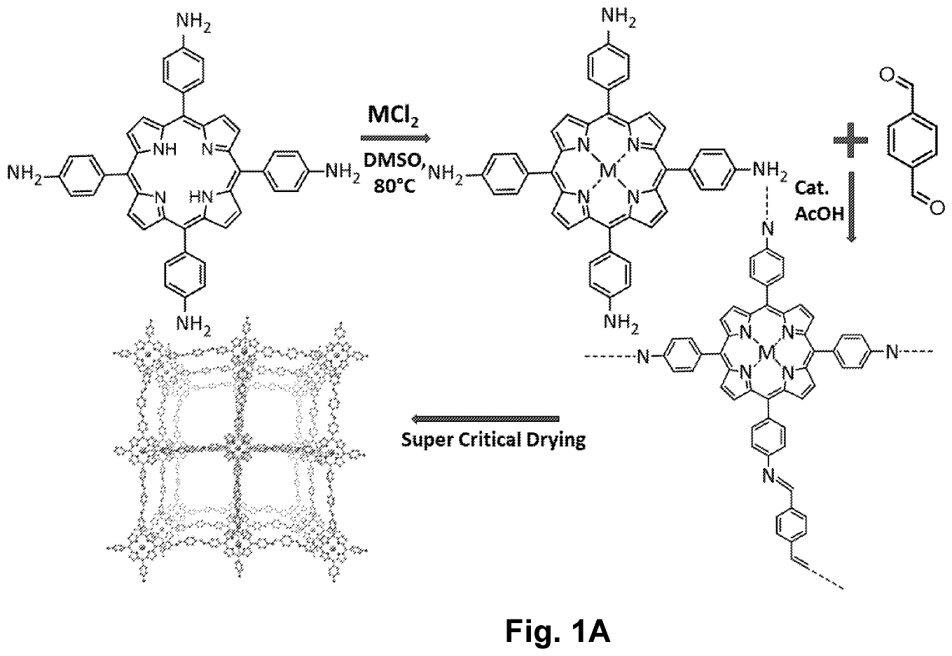

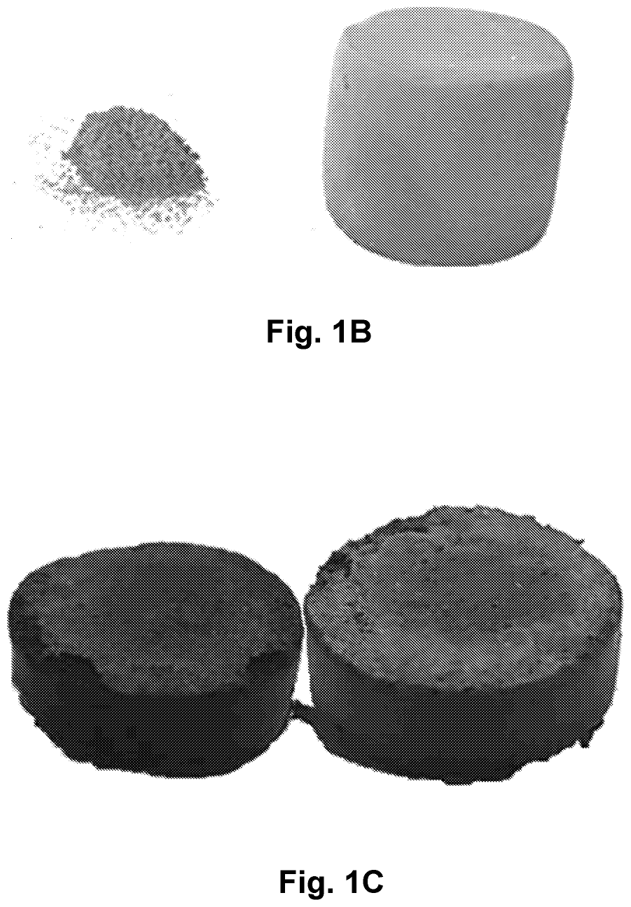

A specific, non-limiting, example of the process for preparing an aerogel catalyst, which is also known as a metalation-gelation process is shown in FIG. 1A. A transition metal-aerogel complex prepared from Fe and porphyrin (FeP) is shown in FIG. 1B compared to the same amount of porphyrin in powder form. An FeP aerogel subjected to LTHT treatment is shown in FIG. 1C compared to a similar gel that did not undergo LTHT.

The transition metal-aerogel complexes of the present disclosure may be used as catalysts for ORR. The present disclosure further provides the use of the transition metal aerogel complexes described above for catalysis of oxygen-reduction reactions.

In yet another aspect, the present disclosure provides an aerogel catalyst as described above for use in fuel cells, Li-air batteries, CO₂ reduction reaction, electrolyzers and sensors.

Having described the invention with reference to certain preferred embodiments, other embodiments will become apparent to one skilled in the art from consideration of the specification.

The invention will now be described with reference to specific examples and materials. The following examples are representative of techniques employed by the inventors in carrying out aspects of the present invention. It should be appreciated that while these techniques are exemplary of specific embodiments for the practice of the invention, those of skill in the art, in light of the present disclosure, will recognize that numerous modifications can be made without departing from the spirit and intended scope of the invention.

### EXAMPLES

### Materials and Instruments and Methods

Iron-Porphyrin (FeP) Aerogel Characterization:

An Ocean Optics DH-2000-BAL ultraviolet-visible spectrophotometer (UV-Vis) was used to verify the metalation of the aerogel.

The porphyrin molecules in the aerogel were characterized by A Nicolet iS50 Fourier transform infrared spectroscopy-attenuated total reflectance (FTIR-ATR) instrument (Thermo Scientific).

X-Ray Photoelectron Spectroscopy (XPS)

Measurements were performed with Kratos AXIS ULTRA system using a monochromatic Al Kα X-ray source (hυ=1486.6 eV) at 75 W and detection pass energies ranging between 20 and 80 eV. Alternatively, the measurements were performed using a Nexsa spectrometer equipped with a mono-chromated, micro-focused, low power Al Ka X-ray source (photon energy 1486.6 eV at 72W). Curve-fitting analysis was based on linear or Shirley background subtraction and application of Gaussian-Lorenzian line shapes or based on Smart background subtraction using Avantage software (Thermo).

Conductivity measurements were performed using electronic micrometer (INSIZE) and referenced to those of Vulcan XC72 (Cabot), LTHT-P aerogel and heat-treated resorcinol-formaldehyde (RF) aerogel synthesized according to a method described by Pekala et al., Journal of Materials Science 24: 3221-3227 (1989).

Thermal gravimetric analysis (TGA-GC-MS (EI/CI) was carried out using Clarus 680/Clarus SQ 8C, by Perkin Elmer or using SETSYS, by Setaram. The released products during the TGA measurement were measured using Hiden HPR-20 QIC mass-spectrometer. To examine the size, shape, and content of the particles, high-resolution transmission electron microscope (FEI Titan Cubed Themis G2 60-300) was used.

Morphology

Aerogel morphology was studied using high-resolution scanning electron microscope (HR-SEM) Magellan 400 L.

To examine the size, shape, and content of the particles, high-resolution scanning transmission electron microscope (Nion UltraSTEM U100 operated at 60 kV) was used.

The surface area of the LTHT aerogel was measured and calculated from the Brunauer-Emmett-Teller (BET) N₂ adsorption isotherm at 77 K (Quantachrome Autosorb iQ.

Nuclear magnetic resonance (NMR) measurements of the porphyrin were performed in DMSO using Bruker 700 Hz spectrometer. To verify the crosslinking site, terephthalaldehyde solution (in DMSO) was added in portions over time.

Induced coupled plasma (ICP) (SPECTRO ARCOS ICP OES, FHX22, MultiView plasma) was performed for Fe(III)-5,10,15,20-(tetra-4-aminophenyl) porphyrin (Fe-TAPP) aerogel (it should be noted that Fe(II) is oxidized to Fe(III) immediately upon exposure of the aerogel to air). The sample was prepared by heating under air, at 800° C., overnight, 2.82 mg of FeP aerogel. The iron remained after the treatment, was dissolved in concentrated 1:1 HCl:HNO₃, and diluted for the analysis.

Electrochemistry

The electrochemical measurements were conducted in 0.1 M KOH (Acros, 99.98%) using Bio-Logic VMP 300 bipotentiostat. 10 mg of low temperature heat treated Fe-porphyrin (LTHT-FeP) aerogels were grinded and suspended in 1 mL of ⅔ isopropanol: ⅓ de-ionized water (volume ratio). Then, 10 μL of the aerogel slurry was deposited onto a glassy-carbon rotating ring disk electrode (Pine, 5.61 mm diameter). The reference electrode was a reversible hydrogen electrode (RHE, platinized platinum in the electrolyte solution bubbled with pure hydrogen, 99.99%) and the counter electrode that was used is a glassy carbon rod.

Oxygen-Reduction Reaction

The ORR with all materials synthesized in this disclosure was studied using a rotating ring disk electrode (RRDE). The ORR polarization plots were conducted using 5 mV/s scan rate at 900 rpm, between 0.02 V and 1.0 V vs. RHE.

### Example 1

Fe-TAPP Aerogels Synthesis

The Fe-porphyrin aerogels of the present disclosure were synthesized according to the following procedure: 15 mg of iron(II) chloride tetrahydrate (FeCl₂.4H₂O 99+%, ARCOS ORGANICS) were dissolved in 250 μL dimethyl sulfoxide (DMSO), followed by the addition of the monomer for the polymerization, the monomer being free base porphyrin, 5,10,15,20-(tetra-4-aminophenyl)porphyrin (TAPP) (98%, PorphyChem) (10 mg). For the purpose of metal insertion process, the solution was heated to 80° C. and stirred for 30 minutes. To form the gel, a solution containing terephthalaldehyde (98%, Alfa Aesar) as the cross-linker dissolved in DMSO with a 1:2 molar ratio of —NH₂ to —CHO. 250 μL of the cross-linker solution was added dropwise to the porphyrin-iron solution. The new solution was heated to 80° C. and stirred for 10 seconds (the magnetic stirrer was immediately pulled out due to the fast gelation), after which the solution was incubated at 80° C. overnight. Once formed, the gel was washed by immersing it in fresh DMSO once a day, for four consecutive days, to remove unreacted chemicals until no residues were seen in the solvent above the gel. Then, the gel was washed with acetone in order to replace the DMSO in the pores. Finally, the gel was dried using CO₂ under supercritical conditions in a critical-point dryer (tousimis® 931GL) to yield the aerogel.

The heat treatment was carried out in a glass-tube oven (Thermo Scientific-Lindberg Blue M) under argon (MAXIMA). In one experiment, the temperature was increased from 25° C. to 600° C. for five hours (i.e., at the rate of 2° C./min) and then held at 600° C. for two hours. In a second experiment, the temperature was increased from 25° C. to 200° C., and then held at 200° C. for 2 hours, in order to completely dry the aerogel and prevent formation of oxide layer on its surface. Then, each aerogel was heated to a different desired temperature (600° C., 700° C., 800° C., 900° C. and 1000° C.) at a rate of 2° C./min, and held for two hours at each desired temperature.

### Example 2

Characterization of Fe-TAPP Aerogels

An aerogel was synthesized according to the method of the invention using iron(II) chloride tetrahydrate as transition metal salt and free base 5,10,15,20-(tetra-4-aminophenyl)porphyrin (TAPP) as the macrocyclic compound. The resulting Fe-TAPP aerogel was characterized using various techniques.

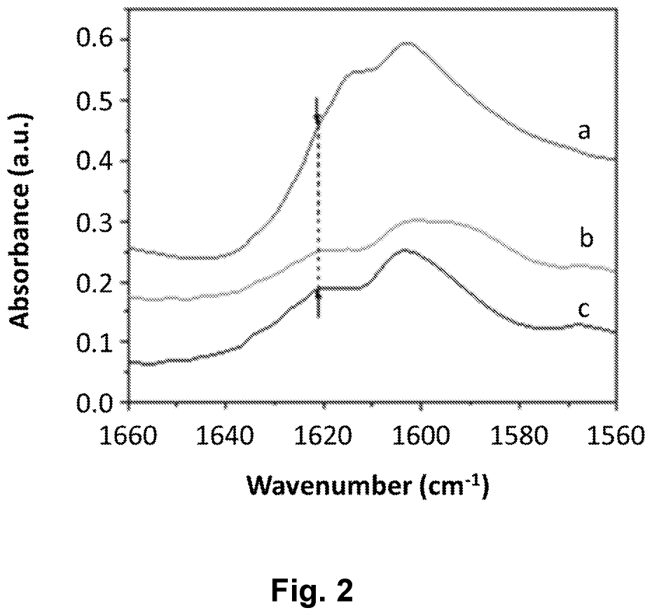

As shown in FIG. 2, the peak at 1621 cm⁻¹ is attributed to a newly formed C=N bond linking the porphyrin molecules, expected for the imine groups.

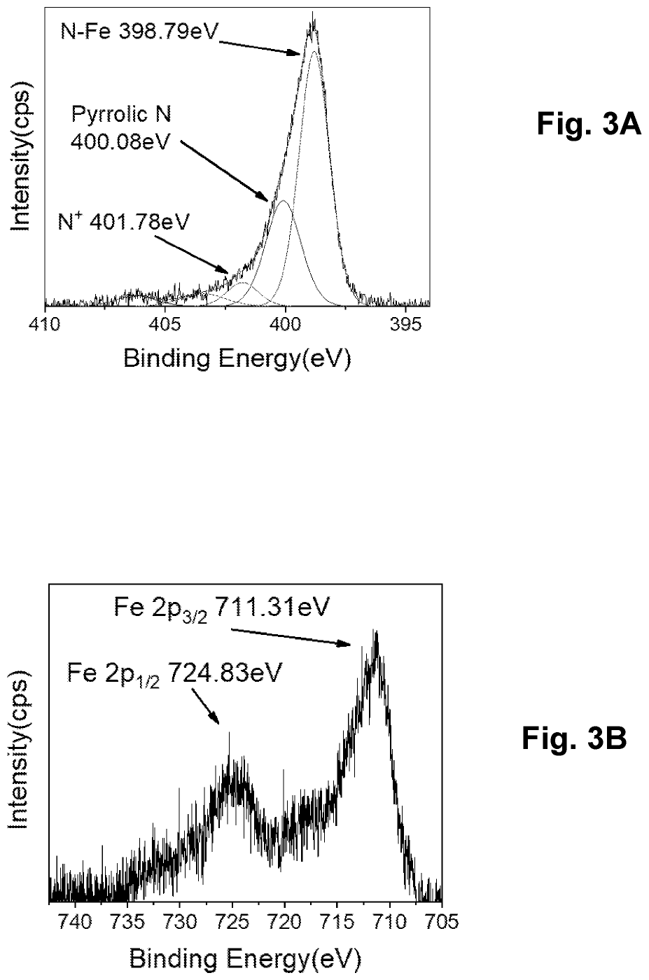

The interaction between the metal ion and the pyrrolic nitrogen atoms in the porphyrin aerogel was investigated by XPS. The N 1s spectrum shown in FIG. 3A can be de-convoluted into five distinct peaks, with the most pronounced of them detected at a binding energy of 398.79 eV. This N 1s peak is assigned to a new N—Fe bond formed with the porphyrin center during the aerogel synthesis. The peak located at 400.08 eV is related to pyrrolic groups. Charged nitrogen species, originating from amine- or imine-like bonds, can be seen at 401.78 eV. The Fe 2p spectrum shown in FIG. 3B reveals trivalent iron with peaks at binding energies of 711.31 and 724.83 eV, supporting coordination of the iron ion to pyrrolic nitrogen in the porphyrin core. The calculated N:Fe atomic ratio is 8.57:1, very close to the theoretical ratio expected for Fe-TAPP (8:1), pointing to a high metalation yield (ca. 93%). Importantly, no metallic iron or iron oxide were found in the aerogel.

Furthermore, the iron content in the Fe-TAPP aerogel described above was 6.4 wt. %, as confirmed by induced coupled plasma (ICP) measurements. This value indicated a higher metal content in the aerogels of the invention compared to known PGM-free ORR catalysts.

### Example 3

Characterization of LTHT-Fe-TAPP Aerogels

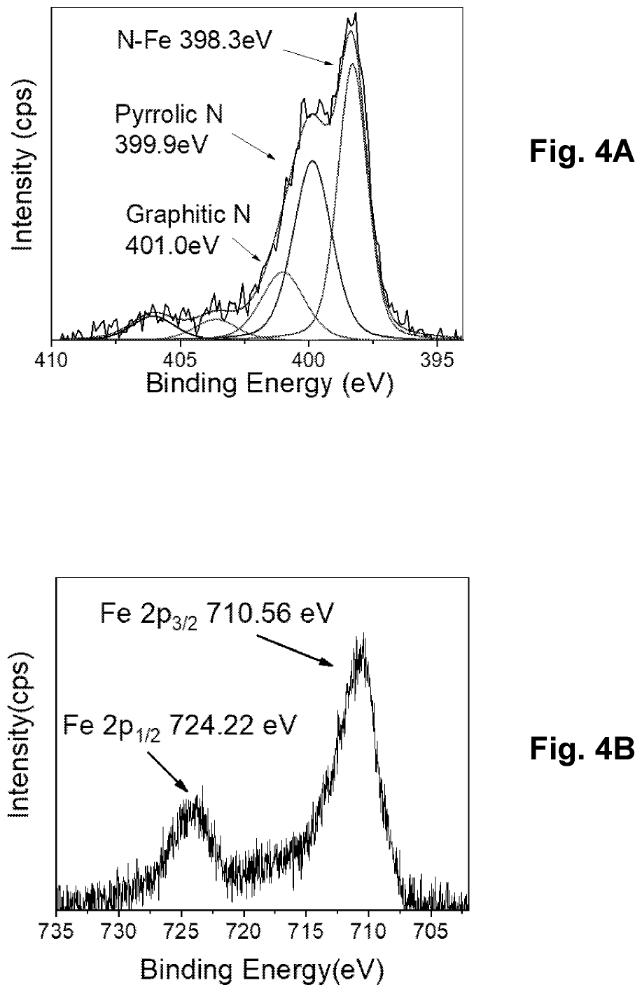

XPS characterization of the Fe-TAPP aerogel after LTHT at 600° C. reveals the presence of the N—Fe bond at 398.35 eV (FIG. 4A), which was also observed with the non-heat-treated aerogel. No metallic Fe was detected in the LTHT-Fe-TAPP aerogel, with all iron remaining at Fe(III) state. The N:Fe atomic ratio in the heat-treated aerogel was found to be 6.5:1, which is less than that of ca. 8:1 before the heat treatment. The small shift in the N—Fe bond energies observed after the LTHT is attributed to the loss of the Cl⁻ counter ion, which was attached to the Fe in the porphyrin in the Fe-TAPP aerogel. The Fe:Cl atomic ratio increased from 1.48:1 before the LTHT, to 5.27:1 after LTHT, indicating that fewer chloride counter ions were involved in the coordination bond with the iron after the heat treatment. Change of ligands during LTHT led to changes in the binding energies of Fe, as indicated by both Fe 2p and N 1s spectra before and after LTHT. The N 1s peak assigned to pyrrolic N at 399.9 eV indicates that the iron ion environment did not change significantly after the LTHT. Graphitic-N was also detected in the LTHT-Fe-TAPP aerogel, which may originate from either non-reacted aniline groups in the porphyrin or the cross-linked imine bond. These results were in full agreement with Fe 2p 3/2 spectra (FIG. 4B).

Furthermore, the iron content in the LTHT-Fe-TAPP aerogel was 9.0 wt. %, which indicated an increase in the metal content compared to the non-heat treated aerogels.

In addition, the electronic conductivity of the LTHT-Fe-TAPP aerogel was to 2.7 S cm⁻¹.

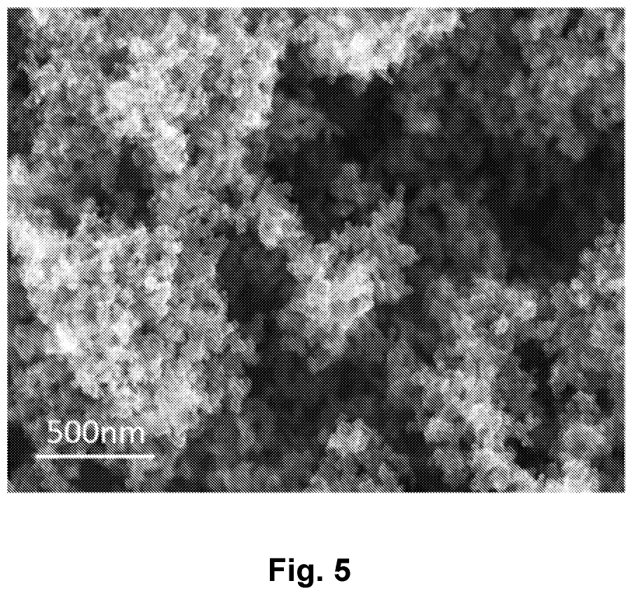

The morphology of the LTHT-treated Fe-TAPP aerogel was studied using HR-SEM. As shown in FIG. 5, the aerogel maintained its porosity and physical structure after the LTHT. The BET surface area of the LTHT-Fe-TAPP aerogel was 191 m²/g, compared to 312 m²/g before LTHT.

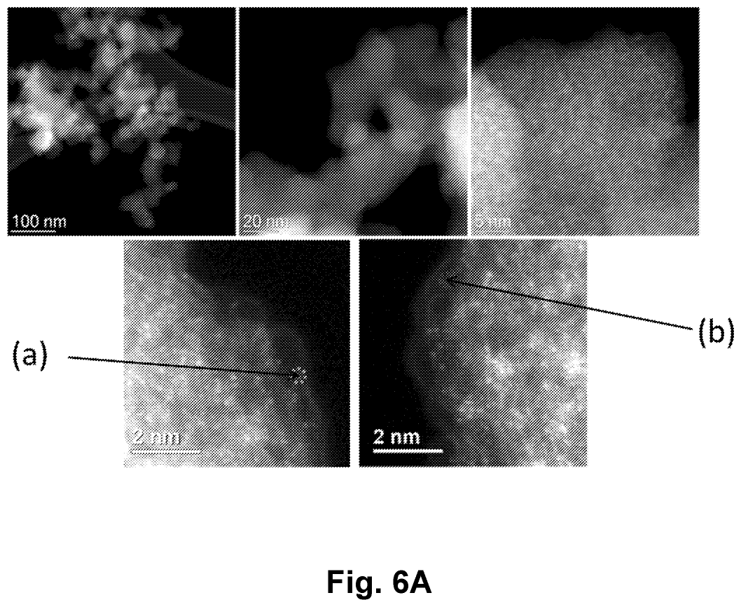

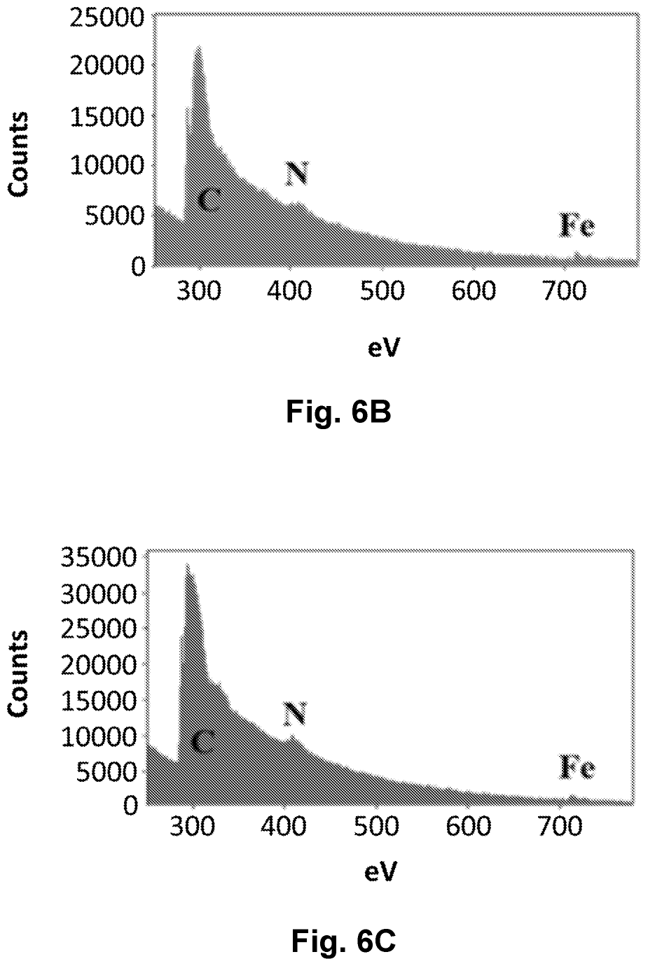

The high-angle Annular dark-field STEM (HAADF-STEM) images shown in FIG. 6A and the electron energy loss point spectra (EELS) shown in FIG. 6B reveal that the nanoparticles are composed of atomically dispersed Fe atoms imbedded in nitrogen-doped carbonaceous material. Despite the high Fe loading, no Fe nanoparticles were found in the sample, although some clustering was observed. Quantification of EELS data obtained from several particles showed the N:Fe atomic ratio to be 8.3:1.0 and 6.9:1.0 for Fe-TAPP and LTHT-Fe-TAPP aerogels, respectively. The EEL point spectra confirmed that the observed atoms are Fe, and the presence of N within the spectra corroborates the Fe-N bonding observed by XPS.

### Example 4

Catalytic Activity of Fe-TAPP Aerogel

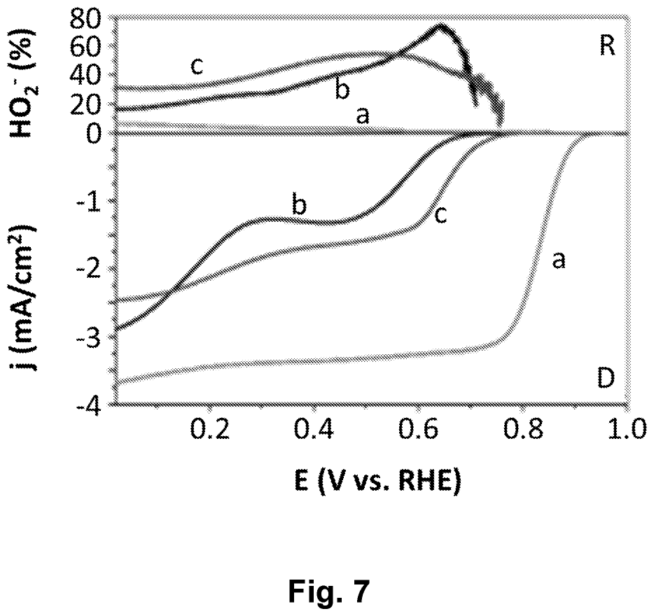

The ORR catalytic activity of the synthesized aerogels was studied using rotating ring disk electrode (RRDE) in alkaline environment (FIG. 7). LTHT-Fe-TAPP aerogel (LTHT at 600° C.) was compared to Fe-TAPP aerogel (without LTHT) and LTHT-TAPP aerogel (without Fe). The LTHT-Fe-TAPP aerogel showed significantly higher performance with Eₒₙₛₑₜ=0.92 V and E_{1/2} =0.83 V vs. reversible hydrogen electrode (RHE), whereas the Eₒₙₛₑₜ measured with the LTHT-TAPP aerogel, devoid of any metal, is only 0.76 V and E_{1/2}=0.65 V vs. RHE, which is still higher than the Eₒₙₛₑₜ=0.69 V and E_{1/2} =0.57 V vs. RHE, obtained with Fe-TAPP aerogel without heat treatment. The limiting current density measured with the LTHT-Fe-TAPP aerogel attests to four-electron oxygen-reduction to water, whereas the limiting current values measured with LTHT-TAPP aerogel and Fe-TAPP aerogel point to partial, and therefore less efficient, two-electron reduction of oxygen to hydrogen peroxide. This was also supported by the ring currents, showing the amount of HO₂⁻ produced during the reaction as a function of the disk potential. The peroxide anion yield changes from zero at high potentials (0.92-0.72 V vs. RHE) to 6% at 0.02 V vs. RHE for the LTHT-Fe-TAPP aerogel. This value is much lower than the peroxide yield values measured for both Fe-TAPP and LTHT-TAPP aerogels (14.5 and 31% at 0.02 V vs. RHE, respectively).

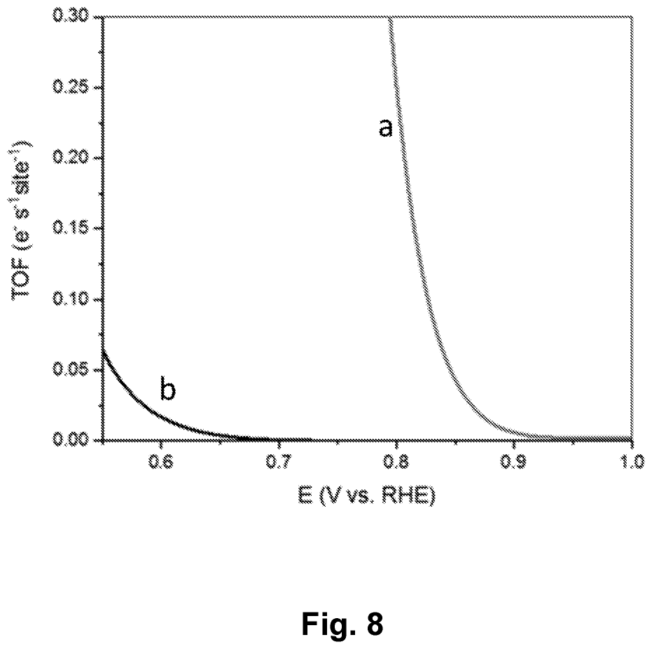

FIG. 8 shows the turnover frequency (TOF) values, which were calculated from the kinetic current extracted from the RRDE data and site density values, assuming all sites are available for ORR electrocatalysis. The TOF values were found to be 0.065 e⁻site⁻¹ s⁻¹ at 0.55 V vs. RHE and 0.25 e⁻site⁻¹ S⁻¹ at 0.8 V vs. RHE for the Fe-TAPP and LTHT-Fe-TAPP aerogels, respectively.

### Example 5

Effect of LTHT at Different Temperature on Fe-TAPP Aerogel Characteristic

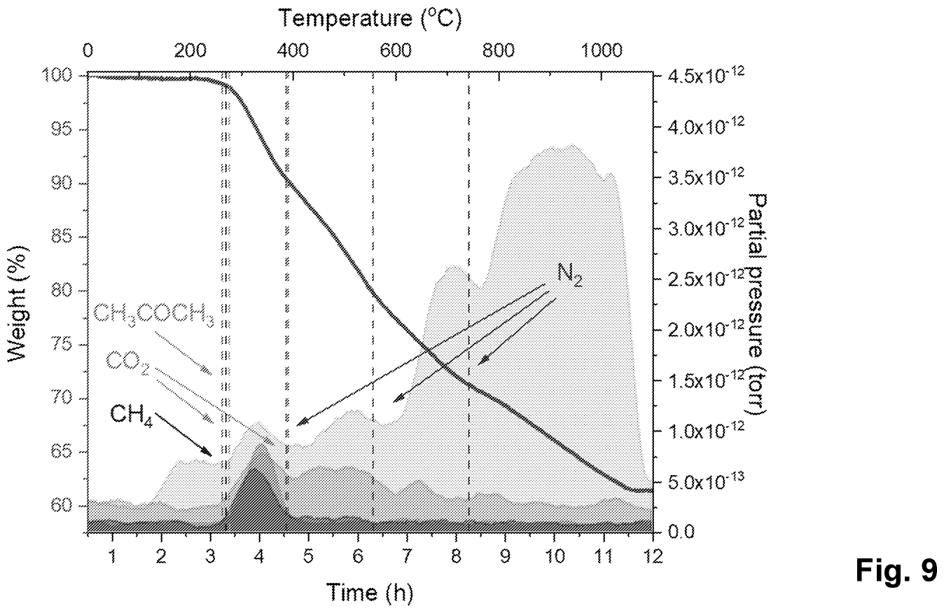

Thermal gravimetric analysis (TGA) coupled with mass spectra (MS) analysis were conducted in order to study the effect of the LTHT on the composition of the HT-FeP-aerogels. The aerogel samples were heated up to 1000° C. under inert atmosphere. The mass loss from the samples was up to 40 wt %, at 1000° C. (FIG. 9). Four main mass drops were observed at approximately 270, 390, 550 and 740° C. The MS results show that the first mass drop can be attributed to the release of CO₂, CH₄ and CH₃COCH₃ molecules, CO₂ and N₂ release at the second mass drop, and predominantly N₂ releases at the third and fourth mass drops. The release of other molecules, such as nitrogen dioxide, nitric oxide, methane, and ammonia, was not detected during the LTHT process.

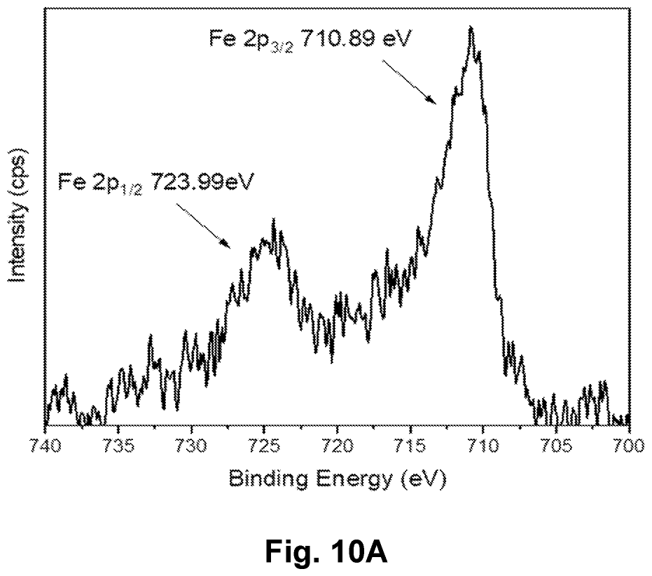

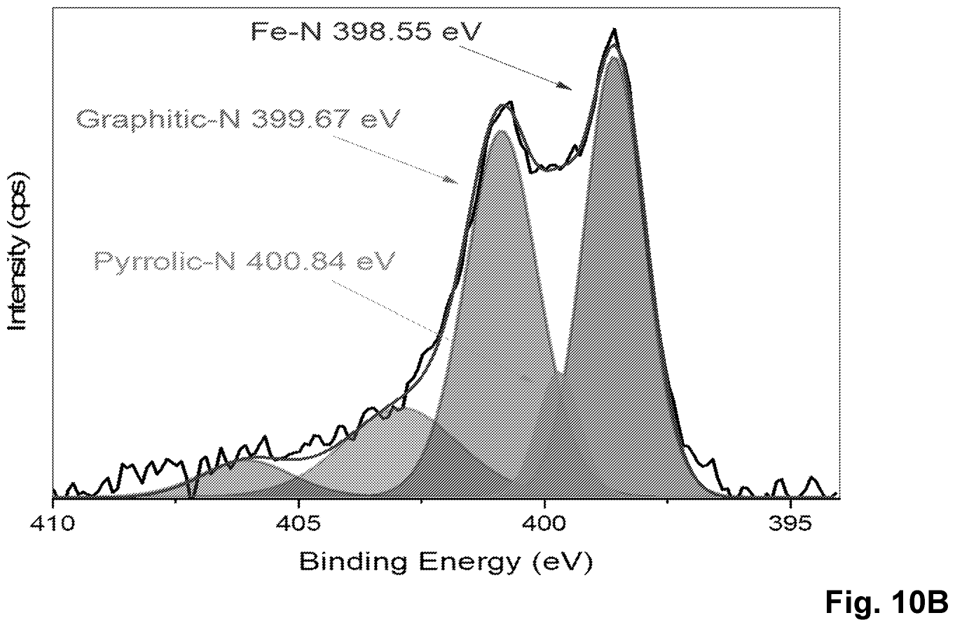

To further understand the molecular changes that may have taken place during the HT, X-ray photoelectron microscopy (XPS) was used. The Fe2p spectra of the Fe-TAPP aerogel after LTHT at 800° C. shown in FIG. 10A reveal only iron in its +3 oxidation state devoid of traces of metallic iron. The Fe 2p peaks of the Fe-TAPP aerogel before the LTHT were shifted by ca. 0.5 eV due to the loss of the chloride counter ion of the porphyrin. Further changes were observed in the Fe-TAPP aerogels heat treated at 900° C. and 1000° C. that are attributed to the formation of oxides (the Fe 2p 3/2 peak shown in Table 1 can be deconvoluted into two peaks for the Fe—N and Fe—O species).

In general, the N 1s spectra of the LTHT-Fe-TAPP aerogels (FIG. 108) has three main peaks which can be associated with an N—Fe bond (at 398.55 eV), pyrrolic N (at 399.67 eV), which most probably originates from pyrrole groups in the porphyrin, and graphitic N peak (at 400.84 eV) which can be attributed to the imine cross-linking units and unreacted aniline groups in the porphyrin, which during the HT, reorganized as graphitic N.

The binding energy values for N 1s and Fe 2p deconvoluted values of the aerogels are summarized in Table 1.

TABLE 1
Binding energy values for N 1s and Fe 2p deconvoluted
values of the LTHT-Fe-TAPP aerogels
Binding Energy (eV)

| | Element | | | | | |
|---|---|---|---|---|---|---|
| | N 1s | | | | Fe 2p | |
| Sample | N—Fe | Pyrrolic-N | Graphitic-N | Oxidized-N | 2p_{3/2} | 2p_{1/2} |
| FeP | 398.77 | 400.13 | — | 403.98 401.93 | 711.4 | 724.5 |
| HT600FeP | 398.51 | 400.15 | 400.99 | 404.37 402.41 | 710.88 | 723.98 |
| HT700FeP | 398.52 | 399.66 | 400.66 | 404.27 402.23 | 710.89 | 723.99 |
| HT800FeP | 398.55 | 399.67 | 400.84 | 406.04 402.89 | 710.89 | 724.01 |
| HT900FeP | 398.65 | 399.8 | 400.8 | 405.94 404.14 402.22 | 711.14 | 724.24 |
| HT1000FeP | 398.66 | 400.01 | 400.92 | 406.41 404.48 402.74 | 711.15 | 724.25 |

According to the XPS spectra taken at the various HT temperatures, the higher the temperature, the lower the amount of pyrrolic N and the higher the amount of graphitic N. In parallel to the change in the nature of the nitrogen in the catalyst matrix, loss of atomic N was detected with the rise of LTHT temperature. The atomic percentage of N decreased from 9.94 atomic % N for pristine (non-LTHT) Fe-TAPP aerogel, down to 2.12 atomic % N for the LTHT aerogel at 1000° C.

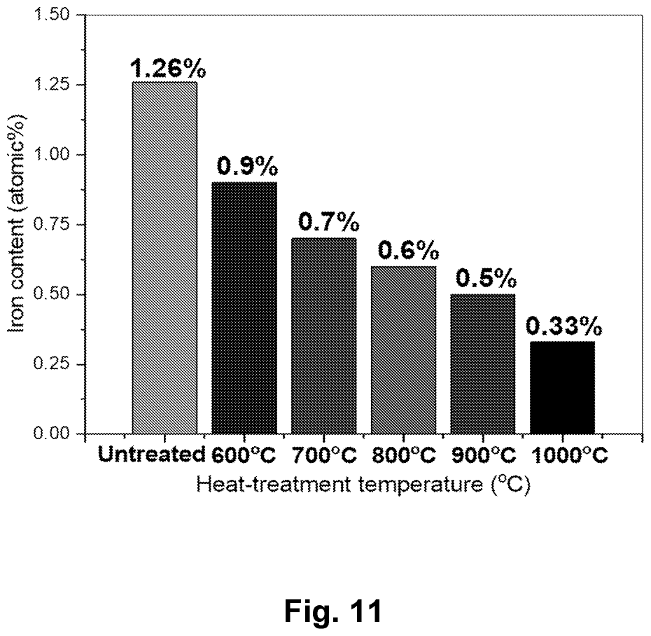

The loss of atomic N was also manifested in the loss of Fe, which show a decrease in the loading thereof as the LTHT temperature increases, starting with 1.26 atomic % Fe for pristine Fe-TAPP aerogel, down to 0.33 atomic % Fe for the 1000° C.-treated Fe-TAPP aerogel (FIG. 11). The decrease in iron content can be explained by the loss of coordination to N moieties. Fe coordinated by pyridinic N was found to be more active than its pyrrolic analogue. Therefore, although some of the catalytic sites are lost due to the loss of nitrogen during the LTHT, this loss facilitates the formation of more active catalysts. Hence, the tradeoff between site density (SD) and activity in Fe-TAPP aerogels has an optimum that depends on the temperature of the LTHT process.

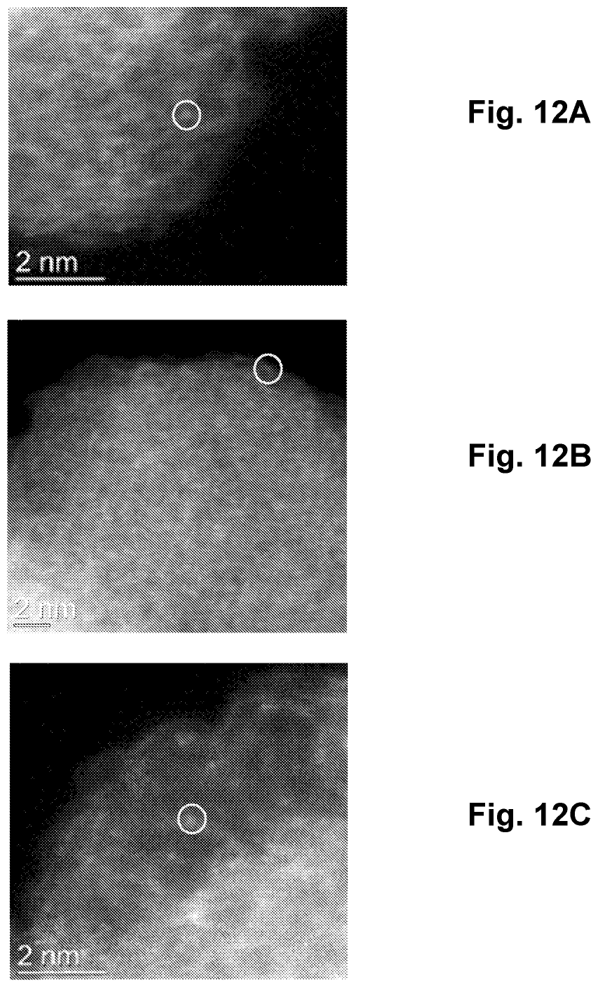

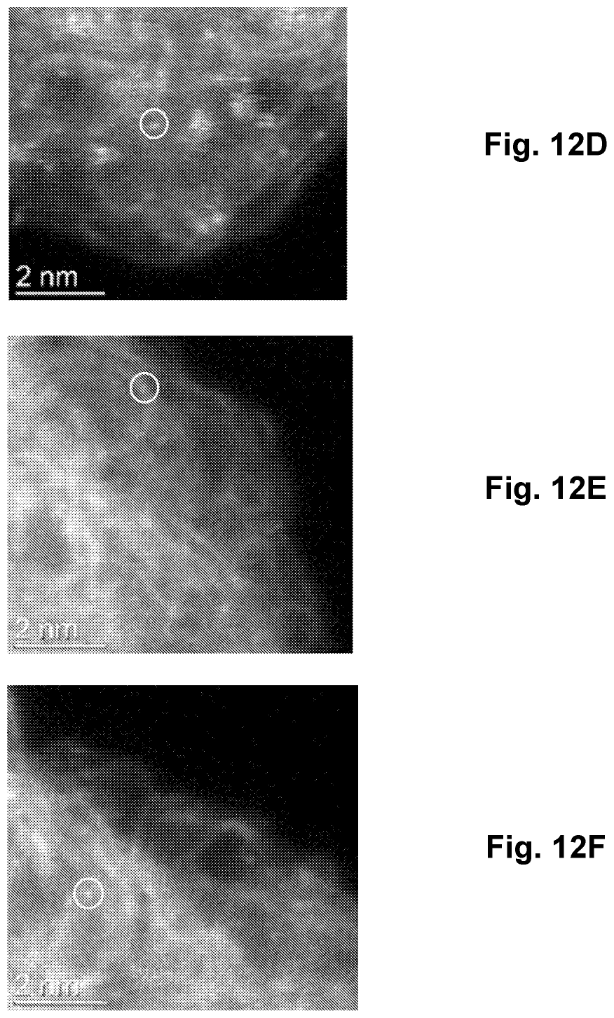

The homogeneity of the catalytic sites was studied using HAADF-STEM. The images in FIGS. 12A to 12F suggest that the LTHT-Fe-TAPP aerogels are composed of atomically dispersed Fe ions in a carbonaceous material. When comparing between the aerogels, the pristine Fe-TAPP aerogel (FIG. 12A) has the similar iron dispersity to that observed after LTHT at 600° C., 700° C., 800° C., 900° C. and 1000° C. (FIG. 12B to 12F, respectively), while a decrease in loading was observed. The graphitization level increased with the temperature of the LTHT. Although some iron-oxide was observed in both XPS and STEM images, no Fe nanoparticles were found in any of the samples.

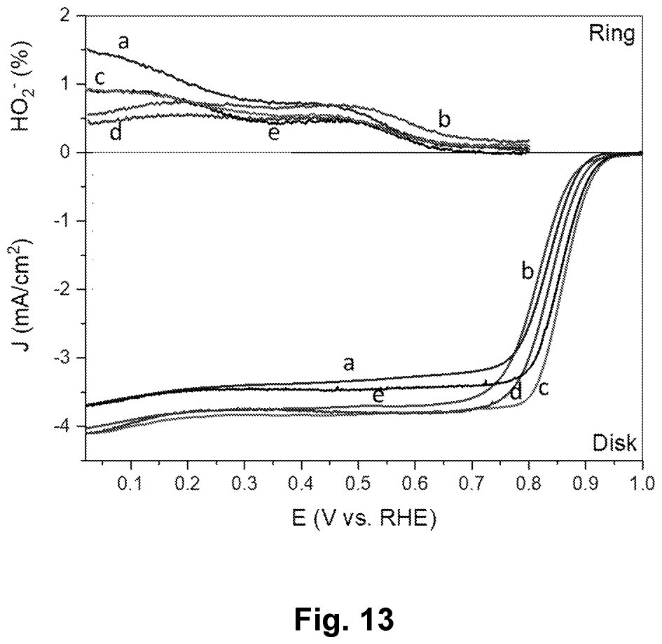

The ORR catalytic activity of the LTHT-Fe-TAPP aerogels was studied using rotating ring disk electrode (RRDE). FIG. 13 shows that increasing the LTHT temperature increases the ORR activity of the Fe-TAPP aerogel up to some point, from which it begins to decline. Out of the five measured samples, the aerogel treated at 800° C. had the highest catalytic performance with an onset potential of 0.96 V vs. RHE and half-wave potential of 0.86 V vs. RHE, while the other aerogels showed lower ORR onset and half-wave potentials. FIG. 13 also shows the amount of HO₂⁻ produced during the reaction and measured on the ring electrode, as function of the disk potential, which supports that the ORR for the aerogels fits with the four electrons reduction mechanism. Except for the Fe-TAPP aerogel heat-treated at 600° C., where the ring current corresponds to 1.5% peroxide anion formation, the four other HT aerogels heat treated at 700° C., 800° C., 900° C. and 1000° C. produced less than 1% peroxide anion.

The atomic percentage of Fe in the aerogels was confirmed by XPS, and ICP, which both showed very similar values for all LTHT-Fe-TAPP aerogels. Based on these values, the maximum site density (SDₘₐₓ) was estimated, by taking into account that all Fe sites in the aerogel are available for ORR. Using the SDₘₐₓ, and the kinetic currents from RRDE data described above, the ORR turnover frequencies (TOF) were calculated according to Equation (1) described above.

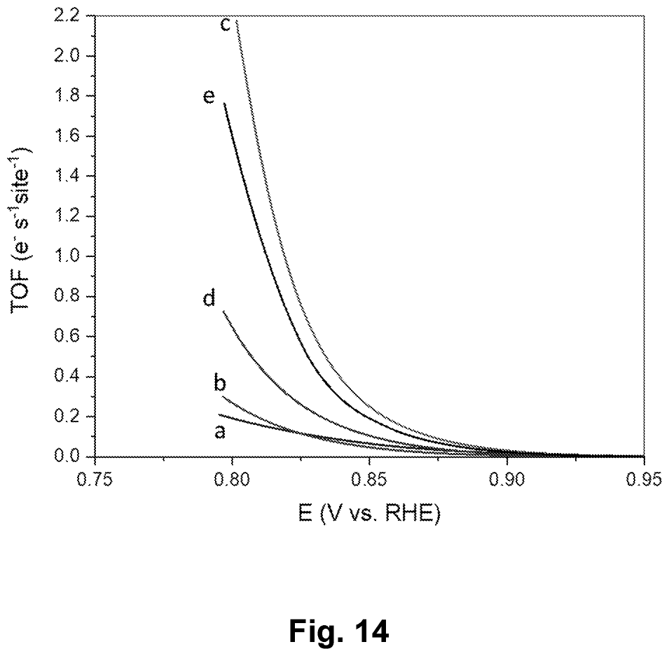

The results in FIG. 14 show that the lowest TOF value recorded was that of Fe-TAPP aerogel treated at 600° C. (0.2 e⁻ s⁻¹ site⁻¹ at 0.8 V), whereas the highest TOF value was recorded for the Fe-TAPP aerogel treated at 800° C. (2.1 e⁻ s⁻¹ site⁻¹ at 0.8 V). The results thus indicate a significant improvement of up to one order of magnitude in the TOF between the lowest and highest TOFs.

### Example 6

Copper-(tetra-4-aminophenyl)Porphyrin (Cu-TAPP) Aerogel Synthesis 10 mg of Cu-TAPP were dissolved in 250 μl of DMSO, followed by addition of 250 μl of the cross-linker, terephthalaldehyde, in a 2:1 ratio of cross-linker to monomer. The solution was then left overnight under heating at 80° C. to form a gel. The gel then underwent solvent exchange from DMSO to acetone and was dried with super-critical CO₂. The aerogel was then subjected to LTHT in order to increase its conductivity and improve its ORR activity.

It should be noted that unlike Fe-TAPP complexes, Cu-based complexes are not prone to aggregation prior to polymerization. Therefore, in contrast to the synthesis of Fe-TAPP aerogels, in which Fe-metalation of the porphyrin molecules occurred during the polymerization of the gel to prevent aggregation, the porphyrin monomers can be Cu-metalated prior to the polymerization step.

1. An aerogel catalyst comprising a central transition metal complex comprising macrocyclic compounds as ligands and cross-linkers for use in oxygen-reduction reactions.

2. An aerogel catalyst according to claim 1, wherein the aerogel catalyst has a catalytic site density of 1×1019 to ×1020 sites cm-3.

3. The aerogel catalyst according to claim 1, wherein the transition metal is selected from the group consisting of iron, cobalt, copper, nickel, vanadium, manganese, chromium, ruthenium, rhodium, iridium, osmium, rhenium, molybdenum, tungsten and any combination thereof.

4. The aerogel catalyst according to claim 1, wherein the macrocyclic compound is porphyrin, phthalocyanine, phenanthroline, corrole or bipyridine.

5. The aerogel catalyst according to claim 1, wherein the aerogel catalyst has a metal content of about 2 wt. % to about 9 wt. %.

6. The aerogel catalyst according to claim 1, wherein the aerogel catalyst has a Brunauer-Emmett-Teller (BET) surface area of about 150-700 m2/g.

7. The aerogel catalyst according to claim 2, wherein the catalytic site density is 4×1019 sites cm-3.

8. The aerogel catalyst according to claim 5, wherein the metal content is about 6.5 wt. % to about 9.0 wt. %.

9. A process for preparing an aerogel catalyst according to claim 1, comprising the steps of:
(a) heating a reaction mixture at about 60-160° C. to obtain a gel, the reaction mixture comprising:
a solution comprising monomers of a pyrrolic or a pyridinic compound and transition metal ions; wherein the ratio between the metal ions and the monomer in the reaction mixture is from 7:1 to 10:1; and
a solution comprising a cross-linker, such that the molar ratio between the —NH₂ of the monomer to the —CHO of the cross-linker is from 1:1 to 1:4;
(b) washing the gel; and
(c) supercritically drying the gel using high pressure drying liquid to obtain an aerogel; and
(d) subjecting the aerogel to heat treatment of at least 500° C. for at least 1 hour.

10. A process for preparing an aerogel catalyst according to claim 9, wherein step (a) comprises the steps of:
heating a reaction mixture comprising a solvent, monomers of a pyrrolic or a pyridinic compound and transition metal ions at about 60-160° C. for 20 to 60 minutes; wherein the ratio between the metal ions and the monomer in the reaction mixture is from 7:1 to 10:1;
(ii) adding a solution of a cross-linker to the reaction mixture, such that the molar ratio between the —NH₂ of the monomer to the —CHO of the cross-linker is from 1:1 to 1:4; and
(iii) heating the reaction mixture containing the cross-linker at about 60-160° C. to obtain a gel.

11. The process for preparing an aerogel catalyst according to claim 9, wherein the final concentration of the metal ions in the reaction mixture is from 0.25 M to 0.3 M.

12. The process for preparing an aerogel catalyst according to claim 9, wherein the final concentration of the monomer in the reaction mixture is from 10 mg/mL to 200 mg/mL.

13. The process for preparing an aerogel catalyst according to claim 9, wherein the pyrrolic or the pyridinic compound is in the form of a free base or a hydroxyl analogue thereof.

14. The process for preparing an aerogel catalyst according to claim 9, wherein the solvent is dimethyl sulfoxide (DMSO).

15. The process for preparing an aerogel catalyst according to claim 9, wherein the cross-linker is terephthalaldehyde (TPA) dissolved in DMSO.

16. The process for preparing an aerogel catalyst according to claim 9, wherein washing the gel comprises exchanging the solvent of the gel to a washing liquid.

17. The process for preparing an aerogel catalyst according to claim 16, wherein prior to exchanging the solvent of the gel to a washing liquid, the gel is immersed in a fresh solvent of the same type as the solvent used to dissolve the metal ions, monomers and cross-linker, once daily for four days or until no residues of unreacted molecules can be detected in the solvent.

18. The process for preparing an aerogel catalyst according to claim 16, wherein the washing liquid is selected from acetone, methanol, ethanol or isopropanol.

19. The process for preparing an aerogel catalyst according to claim 9, wherein the drying liquid is liquid CO2.

20. The process for preparing an aerogel catalyst according to claim 9, wherein the heat treatment is low temperature heat treatment (LTHT) at a temperature of about 500° C. to about 1000° C.

21. The process for preparing an aerogel catalyst according to claim 20 wherein the LTHT is carried at a temperature of from 800° C.

22. An aerogel catalyst produced according to the process of claim 9.

23. The aerogel catalyst according to claim 1, for use as an oxygen-reduction reaction (ORR) catalyst.

24. The aerogel catalyst according to claim 1 for use in fuel cells, Li-air batteries, CO2 reduction reaction, electrolyzers and sensors.
